(19) United States
(12) Patent Application Publication
(10) Pub. No.: US 2023/0237388 A1
(43) Pub. Date: Jul. 27, 2023

(54) BLOCKCHAIN DIGITAL QUEUEING SYSTEM AND METHOD

(71) Applicant: George Goubran, Irvine, CA (US)

(72) Inventor: George Goubran, Irvine, CA (US)

(21) Appl. No.: 18/101,298

(22) Filed: Jan. 25, 2023

Related U.S. Application Data
(60) Provisional application No. 63/303,755, filed on Jan. 27, 2022.

(51) Int. Cl. G06Q 10/02; H04L 9/32; H04L 67/1097

(52) U.S. Cl. CPC G06Q 10/02; H04L 9/3213; H04L 67/1097

(57) ABSTRACT

A system and method for blockchain-based digital queuing of a request, such as a booking request for a product. The system and method allow making a smart contract between the provider of a product and a receiver booking the product. The smart contract can be stored on a blockchain database, and a sequence crypto token is assigned to the receiver, wherein the crypto token indicates a position in a queue, the queue is of receivers making the booking of the product in order of making the booking.

### CROSS-REFERENCE TO RELATED APPLICATIONS

This application claims priority from a U.S. Provisional Pat. Application Ser. No. 63/303,755, filed on Jan. 27, 2022, which is incorporated herein by reference in its entirety.

### FIELD OF INVENTION

The present invention relates to a system and method for digital queueing of requests, and more particularly, the present invention relates to a blockchain-based system and method for digital queueing of requests for goods, services, performing a task, or providing a service.

### BACKGROUND

Organizations and businesses often use pre-booking for their products. Pre-booking herein refers to showing interest in a product any time before the product is available for sale or an individual is entitled to it. The product, herein, includes goods; tickets for a show, event, or movie; services; rights, such as right to avail a service, right to avail a benefit; right to perform; and opportunities, such opportunity to performing at an event, an opportunity to provide a service including social service. The interest can be in purchasing or renting the product and can be accompanied by a security or a down payment.

The organizations, which include businesses, often offer to pre-book their products. For example, the manufacturers may wish to know the acceptance of their products in the markets before the actual launch of the product. Pre-bookings are also used to avoid the sale rush at the launch, which may cause server downtime and receiver dissatisfaction. Moreover, in the case of limited-edition products, there is often a heavy rush at the product launch to purchase the product. Commonly, bots and cheat software are used at product launches to buy products online in bulk and re-sell them at higher prices. Pre-booking helps to avoid many such scenarios.

Although pre-booking is useful in a variety of ways, organizations still lack good architecture for handling the pre-bookings which often results in disarray and receiver dissatisfaction. Also, an organization may land in legal trouble for failing to fulfill the pre-bookings.

Thus, an industrial need is there for a system and method that overcomes the aforesaid drawbacks with pre-bookings. Moreover, a need is there for a system and method for creating digital queues in general that are backed by authenticity of blockchain.

The product, herein, includes goods; tickets for a show, event, or movie; services; rights, such as a right to avail a service, a right to avail a benefit, a right to perform; and opportunities, such as an opportunity to perform at an event, an opportunity to provide a service including social service. The product can be anything for which several people show interest either to acquire the product or release the product, and the several people can form a queue for their turn to get or release the product.

The queue hereinafter refers to a digital queue.

The transactions of the product may or may not be monetary transactions. Transactions in kind, such as donations, are within the scope of the present invention and services.

The term “receiver” hereinafter refers to a user that receives a product or is entitled to receive the product. The term “provider” refers to a user that provides the product or is entitled to provide the product. It is understood that in certain implementations, the receiver can become the provider and the provider can become a receiver.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a blockchain-based system and method for digital queueing.

It is another object of the present invention that the system and method prevent any confusion or fraud.

It is still another object of the present invention that the system and method can be trustable.

It is yet another object of the present invention that the system and method can provide legal evidence of a position in a queue.

It is a further object of the present invention that the system and method make the process of pre-booking easier and more convenient.

In one aspect, disclosed is a system and method for blockchain-based digital queuing, the method implemented within a system, the system comprising a processor and a memory, the method comprising: receiving, a request for pre-booking a product, through an interface from a first receiver by a booking module, the interface provided by an interface module, and the booking module implemented within the system; assigning the next available position in a digital queue to the first receiver, wherein the digital queue comprises a list of users pre-booking the product in an order of making the pre-booking; processing the pre-booking request and the assigned position to generate a smart contract between a provider of the product and the first receiver; recording the smart contract in a blockchain database; and assigning a sequence crypto token to the first receiver, wherein the sequence crypto token is indicative of the assigned position. The method further comprises notifying, by a tracking module implemented within the system, the first receiver to receive the product; verifying the sequence crypto token received from the first receiver; and upon verification, permitting a transaction between the provider and the first receiver.

In one implementation, the method further comprises: reassigning the sequence crypto token, from the first receiver to a second receiver. The method further comprises notifying, by a tracking module implemented within the system, the second receiver to receive the product; verifying the sequence crypto token received from the second receiver; and upon verification, permitting a transaction between the provider and the second receiver.

In one implementation, the system provides for sub-queuing, wherein the persons different in age, health, gender, and the like can form sub-queues.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram showing an environment of the disclosed system, according to an exemplary embodiment of the present invention.

FIG. 2 is a block diagram showing the architecture of the disclosed system, according to an exemplary embodiment of the present invention.

FIG. 3 is a flow chart showing a disclosed method, according to an exemplary embodiment of the present invention.

FIG. 4 is a flow chart showing a preferred embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

In the disclosure, the method steps may be described in a sequential order, however such methods, may work in alternate orders. In other words, any sequence or order of steps that may be described in this patent application does not, in and of itself, indicate a requirement that the steps be performed in that order. The steps of described method may be performed in any order. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

Disclosed is a blockchain-based system and method for digitally queuing, such as digital queuing of pre-booking for products with the trust of the blockchain platform. The disclosed system and method utilize blockchain technology for digital queuing.

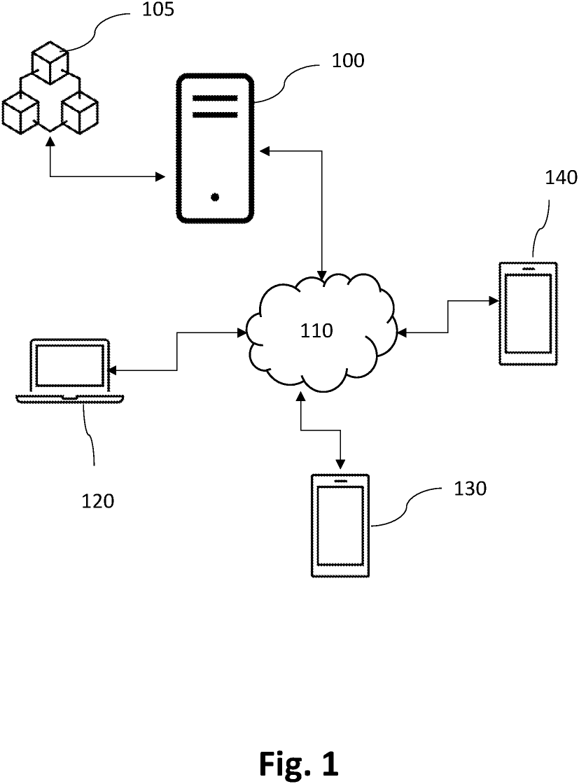

Referring to FIG. 1 is a block diagram illustrating an environment of the disclosed system 100. The system 100 can connect to a blockchain database 105 for recording the transactions, such as per-booking transactions. The disclosed system, through a network 110, can connect to a provider device 120. Through the provider device, pre-bookings and like transactions can be created and advertised. The disclosed system can also connect to a first receiver device 130 through which a pre-booking for a product can be made at the provider’s device or at the system 100. It is to be noted that FIG. 1 shows one first receiver device and one provider device for illustration only. A reader of this specification will appreciate that the disclosed system can connect to multiple receiver devices and multiple provider devices simultaneously and at various times. FIG. 1 also shows a second receiver device 140, wherein a receiver through the first receiver device can resell the rights or “place in the line” to another receiver having the second receiver device. It is to be noted that the terms booking, pre-booking, rights, and “place in the line” are interchangeably used hereinafter.

It is understood that the rights can be sold by the receivers with several other receivers. Moreover, the rights can be resold multiple times and such a chain of transactions can be made and tracked by the disclosed system, such selling, and reselling of the rights is within the scope of the present invention. Such selling of a right from a first receiver to a second receiver and then from the second receiver to a third receiver and so on is also referred to herein as a chain of transactions.

In one implementation, the provider device and the receiver device can be any computing device, such as but not limited to a laptop, workstation, desktop computer, mobile phone, tablet computer, and the like. The provider device and the receiver device may communicate with the disclosed system through the network. The provider device and the receiver devices can send data to the system and receive data from the system through the network. The network can be a wired network, a wireless network, or a combination of a wired network and a wireless network. Examples of the network include a local area network (LAN), a wide area network (WAN), a wireless WAN, a wireless LAN (WLAN), a metropolitan area network (MAN), a cellular data network, the Internet, and the like. FIG. 1 shows a single network connecting the system to multiple devices for illustration only. It is understood that different devices can connect with the disclosed system through different networks and the same device can also connect with the disclosed system through multiple networks.

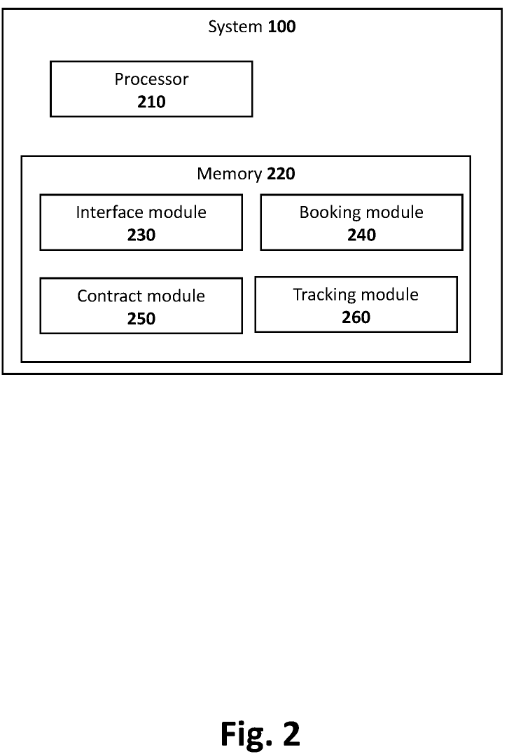

Referring to FIG. 2 is a block diagram illustrating the architecture of the disclosed system 100. System 100 can include a processor 210 and a memory 220. The processor 210 can be any logic circuitry that responds to, and processes instructions fetched from the memory. The memory may include one or more memory chips capable of storing data and allowing any storage location to be directly accessed by the processor. The memory includes modules according to the present invention for execution by the processor to perform one or more steps of the disclosed methodology. The system may also include a network circuitry for connecting to the network.

The disclosed system can be implemented in the form of servers which include cloud servers. The servers include one or more servers that may be located at the same location or geographically dispersed.

The memory can include an interface module 230, a booking module 240, a contract module 250, and a tracking module 260. The module can be a software code, a set of instructions, an algorithm, and the like which upon execution by the processor performs one or more steps of the disclosed methodology. Also, it is understood that one or more steps of the disclosed methodology can also be performed on the receiver device and/or the provider device, without departing from the scope of the present invention.

The interface module upon execution by the processor can provide an interface for interacting with the disclosed system, wherein information can be uploaded to the system from the receiver device and the provider device through the interface and the information can be downloaded to the receiver device and the provider device through the interface. Such an interface can be a graphical user interface.

The interface can be provided as application software that can be installed on the receiver device and the provider device. The application software can be developed for Android®, iOS, and any other known operating platform for mobile devices. The application software can be made available through a distribution service provider, for example, Google Play® operated and developed by Google, and the app store by Apple. In addition to the application software, a website-based interface can also be provided through the world-wide-web. The application software can also be provided for the desktop environment, such as Windows®, Linux, and macOS.

The booking module can provide information about the product and the provider of the product and can receive information about the receiver wishing to pre-book the product. It is understood that per-booking may or may not involve any pre-booking amount. In case, there is a pre-booking amount, the information can be conveyed through the booking module.

The contract module upon execution by the processor can affect a transaction between the provider and the receiver for pre-booking the product and record the details of the transaction in a blockchain. The tracking module can upon execution by the processor can track the reselling of the right and allow the owner of the pre-booking to avail the product when made available based on the place of the receiver in the line or queue. The tracking module may also allow the respective receiver to know their current position in the queue. For example, in case of cancellation of any pre-booking, the positions of others in the queue may change. Similarly, when the process of converting pre-booking to sale, the place in line starts moving and the tracking module can show the current position in the queue.

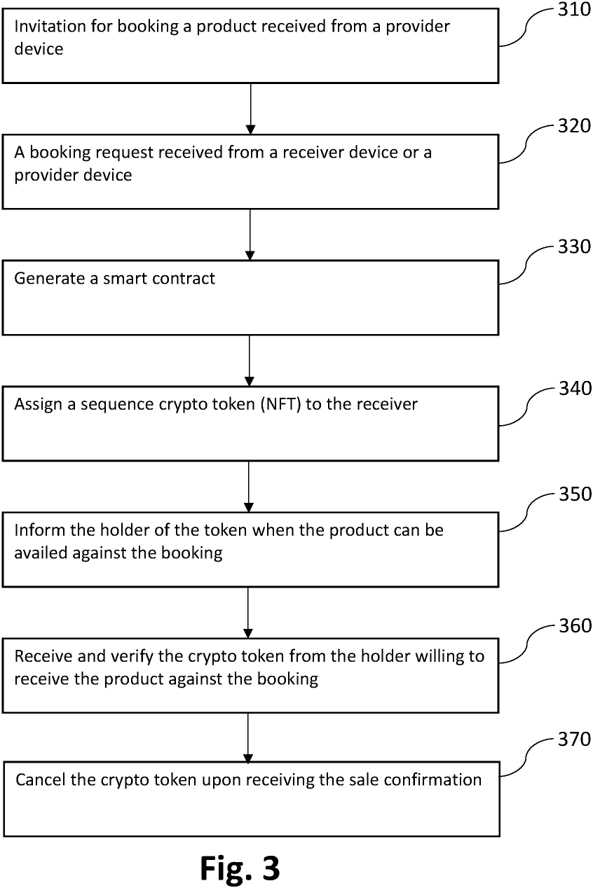

Referring to FIG. 3 is a flow chart illustrating an exemplary embodiment of the present invention. First, an invitation for the pre-booking of a product can be received from a provider device, at step 310. The interface at the provider device allows the provider of the product to provide details, such as a description of the product, expected dates of product launch, pre-booking amount if applicable, and terms and conditions of the provider. It is understood that information from the provider can vary, and any information may be obtained or not obtained from the provider without departing from the scope of the present invention. Receive a pre-booking request from a receiver device or a provider device, at step 320. The description of the product for pre-booking and the pre-booking request can be processed by the booking module. The booking module can show the receiver the details of the product and the terms and conditions of the provider. Consent to the terms and conditions can also be obtained from the receiver making the pre-booking request by the booking module. The pre-booking request can include the details of the receiver making the pre-booking request, such as name, email address, and mobile number. In certain implementations, the receiver may also be required to make a secure account with the disclosed system and can receive login credentials to securely access the disclosed system. Such login using the credentials that include username, password, and the like is within the scope of the present invention. The password can be alphanumeric, biometric, token-based, and the like.

Once, the consent of the receiver to the terms and conditions can be obtained, and the pre-booking request can be verified, the contract module can generate a smart contract, at step 330. The smart contract can be for the pre-booking and include the details, such as details of the provider, the receiver, and the product. Also, the terms and conditions of the provider can be incorporated into the smart contract. Any additional clauses predefined or by the provider can also be incorporated in the smart contract by the contract module, including repeating step 340 through step 360. In certain implementations, the disclosed system may also provide for the automated making of the smart contract based on the details received from the provider.

Upon creating a smart contract, the contract module can assign a sequence crypto token (NFT) to the receiver, at step 340. The contract module can record the transaction and the smart contract on the blockchain. The receiver can mint the crypt token (NFT) to secure their place in the digital queue.

The tracking module can inform the holder of the token when the product can be availed against the pre-booking, at step 350. It is to be noted that the receiver to which the crypto token was issued, and the token holder being notified can be different in the case of the resale of the rights. The tracking module can track such resale of the rights using smart contracts. The tracking module may also provide instructions on how the product can be availed by the token holder.

The tracking module can also receive and verify the crypto token from the holder willing to receive the product against the pre-booking, at step 360 or, the holders can choose to reserve their place in the digital queue. The tracking module can verify the queue position of the holder and upon successful verification can allow the sale transaction to complete. It is understood that, instead of a sale transaction, a booking transaction which is after the pre-booking transaction can also be made by the holder of the crypto token.

The transaction module can then cancel the crypto token and archive the pre-booking transaction upon receiving the sale confirmation, at step 370. The tracking module can then update the positions of others in the queue and inform the next receiver in line.

In certain implementations, when the pre-booking requires a certain pre-booking amount, the transaction may be complete after the booking amount is received from the receiver and the crypto token can then be assigned to the receiver who then becomes the token holder.

In certain implementations, the provider when ready to fulfill the product to which the token holder is entitled because of their “place in line”, the provider can notify the respective token holder via any predetermined method, such as automated app, email, text, posting on discord, etc. The token holder can be provided with instructions on how to claim their place in line and the deliverable.

The use of blockchain in the disclosed system and method provides an advantage by ensuring immutability, authenticity, and ownership rights. The use of blockchain provides for decentralizing the pre-booking data to a public ledger that can easily be verified/audited. Moreover, the use of blockchain may provide legal evidence for contracts, allows tracking of transactions, and also allows making smart contracts.

Furthermore, the disclosed system and method can prevent the loss of revenue of an organization in the resale of rights. The disclosed system and method can provide for tracking of any sale and resale transaction, no matter the number of times the rights have been transacted. Moreover, the use of smart contracts may track the sale amount and thus royalty can be enforced. For example, Mr. A holding a pre-booking i.e., a place in a line which is his right can resell his place or right, and if the selling amount is more than what Mr. A paid for in the smart contract, the profit may attract royalty.

In certain implementations, the holder of the crypto token can be free to sell his right by using any of the available crypto token exchange methods. Moreover, NFT minting and exchange platforms are well-known in the art and any such technologies can be used without departing from the scope of the present invention.

The disclosed system and method can be easily adapted to different businesses and events. Such as an artist expecting to release a new album in the future can issue NFT which allows his fans to declare their commitment to purchase a ticket and “stand in line” well in advance of the concert arrangements being complete. The concert arrangements can be driven by the demand found by the number of fans willing to “stand in line”. In another example, for a future sports event, the fans might want to secure their place in line for tickets to the event before the actual sale of the tickets. The organizers can issue sequence crypto tokens (NFT) that allow the fans to declare their interest and “stand in line” early. When the final plans for the event are complete and the tickets become officially available, the ticket sales can be finalized in an orderly fashion by allowing the token holders the opportunity to purchase their tickets when it’s “their turn”.

The use of blockchain provides transparency in the process and prevents cheating. For example, certain people may by influence or fraud try to jump their position in the queue but cannot do the same because of the authenticity and trust provided by the blockchain.

The disclosed system and method can also be adapted for handling the sale of products in high demand and having a huge backlog in delivery. The manufacturers of such items can issue an NFT which guarantees a receiver’s “place in line” and therefore can route the appropriate amount of inventory to the region based on who is “next in line” to receive available inventory.

Moreover, the disclosed system and method can also be adapted to cover the possibility that someone would create a queue in a metaverse using avatars or NFT characters.

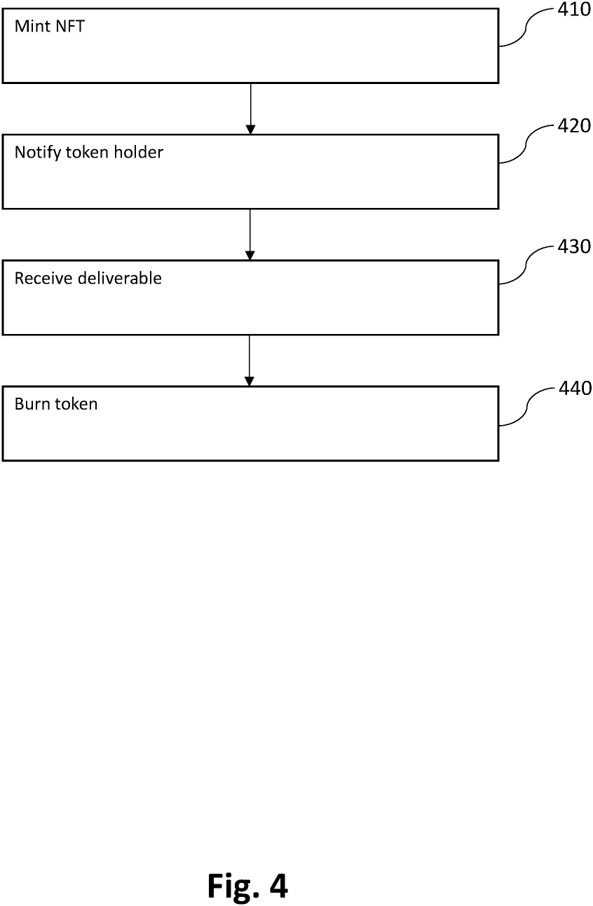

The above embodiments have been described for pre-booking a product; however, the disclosed system and method can be used for digitally queuing in general, wherein a position of a person in a digital queue is secured using the blockchain and NFT. The provider of the product, such as an organization providing vaccination can issue NFT to persons and digitally form a queue, wherein NFT identifies the place of the person in the queue. Such a place in line cannot be manipulated by fraud or intentional by the organization or provider of the product. Referring to FIG. 4 is a flowchart showing an embodiment of the present invention. The vendor or provider of a product, the product includes goods and services, can allow a receiver to mint a crypto token (NFT) that will secure their place in line, at step 410. The receiver has booked or pre-booked a product, such as registered for a vaccine shot. The vendor/provider can then notify the token holder that their turn to complete the transaction has arrived and will provide instructions on how to receive the deliverable, at step 420. The Token holder can then present their token which will verify they are the next in line to complete the transaction and will be allowed to receive their deliverable, at step 430. After the transaction is completed, the token can be “burned” and will no longer be valid for reuse, at step 440.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

1. A method for blockchain-based digital queuing, the method implemented within a system, the system comprising a processor and a memory, the method comprising:
receiving, a request for a product, through an interface from a first receiver by a booking module, the interface provided by an interface module, and the booking module implemented within the system;
assigning the next available position in a digital queue to the first receiver, wherein the digital queue comprises a list of receivers booking the product in an order of making the booking;
processing the booking request and the assigned position to generate a smart contract between a provider of the product and the first receiver;
recording the smart contract in a blockchain database; and
assigning a sequence crypto token to the first receiver, wherein the sequence crypto token is indicative of the assigned position.

2. The method according to claim 1, wherein the method further comprises:
reassigning the sequence crypto token, from the first receiver to a second receiver.

3. The method according to claim 1, wherein the method further comprises:
notifying, by a tracking module implemented within the system, the first receiver to receive the product;
verifying the sequence crypto token received from the first receiver; and
upon verification, permitting a transaction between the provider and the first receiver.

4. The method according to claim 2, wherein the method further comprises:
notifying, by a tracking module implemented within the system, the second receiver to receive the product;
verifying the sequence crypto token received from the second receiver; and
upon verification, permitting a transaction between the provider and the second receiver.

5. A system for blockchain-based digital queuing, the system comprising a processor and a memory, the system configured to implement a method comprising:
receiving, a request for a product, through an interface from a first receiver by a booking module, the interface provided by an interface module, and the booking module implemented within the system;
assigning the next available position in a digital queue to the first receiver, wherein the digital queue comprises a list of receivers booking the product in an order of making the booking;
processing the booking request and the assigned position to generate a smart contract between a provider of the product and the first receiver;
recording the smart contract in a blockchain database; and
assigning a sequence crypto token to the first receiver, wherein the sequence crypto token is indicative of the assigned position.

6. The system according to claim 5, wherein the method further comprises:
reassigning the sequence crypto token, from the first receiver to a second receiver.

7. The system according to claim 5, wherein the method further comprises:
notifying, by a tracking module implemented within the system, the first receiver to receive the product;
verifying the sequence crypto token received from the first receiver; and
upon verification, permitting a transaction between the provider and the first receiver.

8. The system according to claim 6, wherein the method further comprises:
notifying, by a tracking module implemented within the system, the second receiver to receive the product;
verifying the sequence crypto token received from the second receiver; and
upon verification, permitting a transaction between the provider and the second receiver.
